(19) United States
(12) Patent Application Publication
(10) Pub. No.: US 2005/0120230 A1
(43) Pub. Date: Jun. 2, 2005

(54) System for preventing a computer virus accessing email addresses

(76) Inventor: David Lynch Waterson, Auckland (NZ)

Correspondence Address: JACOBSON HOLMAN PLLC, 400 SEVENTH STREET N.W., SUITE 600, WASHINGTON, DC, 20004, US

(21) Appl. No.: 10/920,268

(22) Filed: Aug. 18, 2004

Related U.S. Application Data
(63) Continuation-in-part of application No. PCT/NZ03/00030, filed on Feb. 18, 2003.

(30) Foreign Application Priority Data
Feb. 18, 2002 (NZ) 517257
Aug. 28, 2003 (NZ) 527881

(51) Int. Cl. H04L 9/32; G06F 11/30; G06F 12/14; G06F 15/167

(52) U.S. Cl. 713/188; 709/213; 709/203

(57) ABSTRACT

A system for preventing a computer virus from accessing message addresses is described. The system comprises an interception component or client plug-in that communicates with a messaging client and a messaging server. The interception component alters messages from the server and destined for the client. The interception component replaces message addresses in incoming messages with a unique identifier. The interception component also alters messages from the client destined for the server. The interception component replaces a unique identifier with a message addresses. A system for preventing keyboard sniffer programs from intercepting input, a system for preventing a computer virus from activating a send confirmation of a messaging client and a method for altering displayed objects to show encrypted data in decrypted form are also described and claimed.

### FIELD OF THE INVENTION

The field of the invention generally relates to the prevention of the spread of viruses from a computer system receiving a virus, and in particular to a system for preventing a computer virus from accessing message addresses for further replication.

### SUMMARY OF THE PRIOR ART

Computer viruses constitute a danger for computer users and in particular companies. Many computer virus protection software programs try to prevent computer systems being infected by scanning incoming and outgoing e-mails for virus patterns. These types of virus protection programs depend upon the virus definition files being kept up to date. When a new virus appears there is a window of opportunity for viruses to spread. In even a few hours viruses can spread rapidly, worldwide.

Many viruses carry their own SMTP commands. That is they send outgoing emails without going through the email program. If a virus operates in this manner, then the only way it can replicate is by cracking the encryption technology such as the standard 128-bit encryption. Part of the encryption formula is the user-defined password this differs on each machine. Therefore, if a hacker-initiated virus breaks the encryption, it theoretically would only do so on one machine.

A problem with conventional anti virus systems that rely on standard 128-bit encryption arises via accessing the password. Keyboard sniffer programs exist that can intercept keyboard entries. It is possible (although quite difficult) for a trojan horse program to wait until the user enters a password, and then to intercept the password. Once the virus knows the password, cracking the encryption would be difficult, but possible. If the encryption were cracked, the virus could replicate through the email program, entering via the password itself. Conventional security systems do not offer any protection against password interception. Therefore, what is needed is a new security method capable of defeating a trojan horse attack that intercepts a user's password.

Another point of failure in a conventional anti virus system occurs when the user clicks a confirmation button when sending emails with attachments that could contain a virus. For example, a virus could duplicate user keystroke actions, and activate the confirmation button itself. Thus, what is needed is a way to ensure that no keystrokes can activate the confirmation (for example, OK buttons can generally be activated by the Enter key in addition to a mouse click). This would ensure that the confirmation can only be activated by a user activated mouse click. Mouse clicks are far more difficult for a virus writer to duplicate.

However, it would be possible for a virus writer to establish the co-ordinates of a confirmation button on a screen, program the mouse to go to that position, and then to generate a mouse click at that position. Thus, what is needed is a method for ensuring that a virus cannot find the position of the email activation button.

### SUMMARY OF THE INVENTION

Accordingly it is an object of the present invention to provide a system for overcoming the above-mentioned difficulties by interrupting the spread of viruses through the use of messaging software such as e-mail, and/or to provide a system for preventing a computer virus from accessing message addresses.

In a first aspect the present invention consists in a system for preventing a computer virus from accessing message addresses, said system comprising an interception component adapted to communicate with a messaging client and a messaging server, said interception component including:

means for altering messages from said server destined for said client including:

means for identifying message addresses in messages received from said server;

means for replacing an identified message address in messages received from said server with a corresponding unique identifier; and

means for altering messages from said client destined for said server including:

means for identifying unique identifiers in messages received from said client; and

means for replacing an identified unique identifier with a corresponding message address before sending the message received from said client to said server.

In a further aspect the present invention consists in a system for preventing a computer virus from activating a send confirmation of a messaging client comprising means for preventing keystrokes activating said send confirmation wherein said send confirmation can only be activated by other input means.

In a further aspect the present invention consists in a system for preventing keyboard sniffer programs from intercepting input via a keyboard comprising:

means for adding randomly generated characters into the keyboard buffer between password keystrokes; and

means for reading said keyboard buffer; and

means for reading the stream of said randomly generated characters and removing said randomly generated characters.

In a further aspect the present invention consists in a method of preventing a computer virus from accessing message addresses, including the steps of:

altering messages from a messaging server destined for a messaging client including:

identifying message addresses in messages received from said server;

replacing an identified message address in messages received from said server with a corresponding unique identifier; and

altering messages from said client destined for said server including:

identifying unique identifiers in messages received from said message client; and

replacing an identified unique identifier with a corresponding message address before sending the message received from said client to said server.

In a further aspect the present invention consists in a method of preventing a computer virus from activating a send confirmation of a messaging client comprising the step of preventing keystrokes activating said send confirmation wherein said send confirmation can only be activated by other input means.

In a further aspect the present invention consists in a method of preventing keyboard sniffer programs from intercepting input via a keyboard including the steps of:

adding randomly generated characters into the keyboard buffer between password keystrokes; and

reading said keyboard buffer; and

reading the stream of said randomly generated characters and removing said randomly generated characters.

In a further aspect the present invention consists in a system comprising:

an email or messaging server which sends and receives messages including a message address;

an email or messaging interface which replaces said external address with a unique identifier; and

an email or messaging client which sends and receives messages including a unique identifier.

In a further aspect the present invention consists in a system for preventing a computer virus from accessing message addresses, said system comprising an interception component adapted to communicate with a messaging client and a messaging server, said interception component including:

means for receiving messages from said server and forwarding said messages to said client;

means for identifying message addresses in messages received from said server; and

means for replacing an identified message address in messages received from said server with a corresponding unique identifier.

In a further aspect the present invention consists in a system for preventing a computer virus from accessing message addresses, said system comprising an interception component adapted to communicate with a messaging client and a messaging server, said interception component including:

means for receiving messages from said client and forwarding the messages to said server;

means for identifying unique identifiers in messages received from said client; and

means for replacing an identified unique identifier with a corresponding message address before sending the message received from said client to said server.

In a further aspect the present invention consists in a method of changing data within a data object comprising the steps of:

receiving notification that a user has selected said object;

changing the contents of the said object by decrypting all or part of the contents of the object; and

displaying at least part of said changed object.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

FIG. 1 is a diagrammatic representation of a conventional message client program including message folders and message address book.

FIG. 2A is a diagrammatic representation of a system for receiving incoming email according to one aspect of present invention.

FIG. 2B is a diagrammatic representation a system for sending outgoing email according to one aspect of present invention.

FIG. 3 is a diagrammatic representation of the system operating in an environment including a message address server according to one aspect of the present invention.

FIG. 4A is a diagrammatic representation of the operation of a conventional Keyboard Buffer.

FIG. 4B is a diagrammatic representation of the operation of a Keyboard Buffer when awaiting password input from the keyboard according to an aspect of the present invention.

FIG. 5 is a block diagram of the messaging system of a further embodiment of the present invention.

FIG. 6 is a screen shot showing Outlook™ with a message with message addresses encrypted.

FIG. 7 is a screen shot showing Outlook™ with a message with message addresses not encrypted.

FIG. 8 is a flow diagram of a method according to a further invention herein.

### DETAILED DESCRIPTION OF THE PRESENT INVENTION

Conventional anti-virus software attempts to prevent viruses from entering and leaving the system, by examining incoming and outgoing messages and attempting to identify possible viruses. In contrast, an aspect of the present invention stops viruses from replicating, by preventing viruses from spreading to other systems through the use of message addresses such as e-mail addresses.

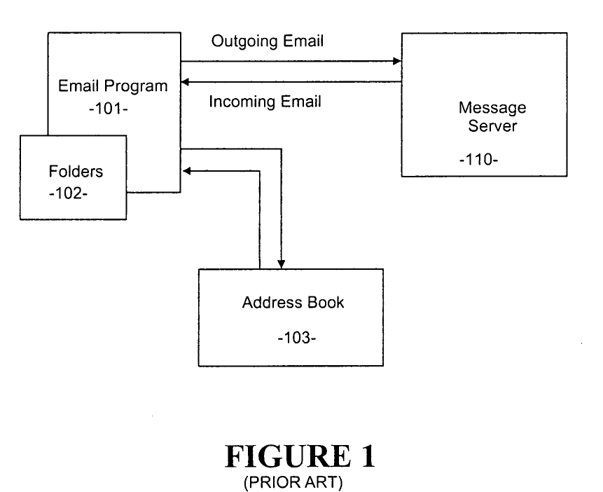

Many viruses replicate by using message addresses found on the infected system. Viruses source message addresses in order to replicate. FIG. 1 shows a typical prior art messaging system. A messaging client 101 connects to a messaging server 110. The client may use an address book 103 for storing email addresses and store messages in message folders 102. Viruses source message addresses by checking folders 102 accessed from within messaging programs such as client 101. Folders 102 such as Inbox, Sent box, Outbox, Drafts, are used for storing messages. Message addresses found in the headers of individual messages are used to replicate the virus.

Another source of message addresses for replicating is the address book 103 that stores details of contacts including message addresses. The virus may then proceed to send itself to the located addresses using its own embedded mail daemon.

The software according to at least one aspect of the present invention encrypts messaging addresses in order to prevent viruses using the addresses. In order to encrypt email addresses within a message, the software first identifies email addresses and then reversibly encrypts the email address and resaves the message. The software intercepts messages being sent to the email client and encrypts addresses immediately. The software intercepts emails being sent and replaces the encrypted addresses with real addresses before the emails reach the server.

In the preferred embodiment, the present invention interacts with an email messaging program and in particular Microsoft Outlook. The present invention can be programmed as a Microsoft Outlook plug-in or as a plug-in for any suitable email client. Alternatively the present invention can be programmed as an executable or library for an suitable messaging client.

Once installed on a computer system the software requests the messaging client application for notification of certain events. These events include when a new message has been received, when a message is about to be sent, when a user has highlighted a particular message or a group of messages, and when a user has added a new address to an address book or modified an existing address in an address book.

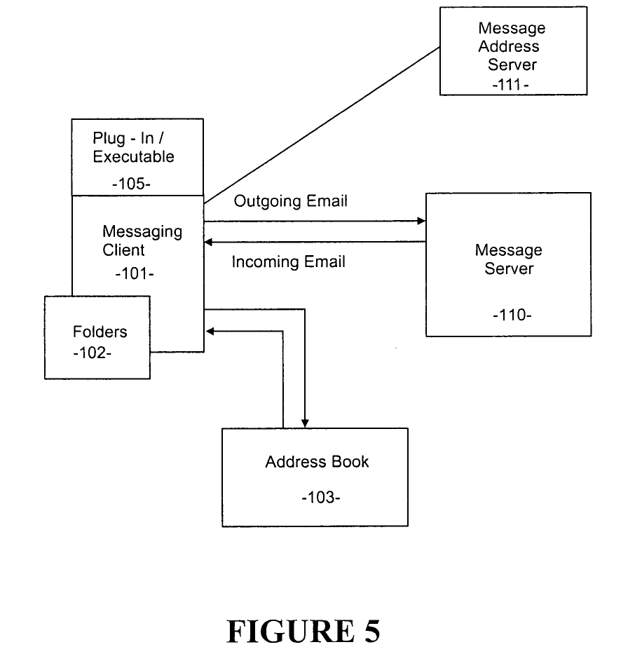

Referring to FIG. 5 one preferred embodiment of the messaging system of the present invention is represented. The protection plug-in 105 is integrated with the messaging client 101. The protection plug-in 105 has a number of modules.

The protection system 105 has a find address module to locate messaging addresses in messages and address book entries. The find address module passes located addresses to an encrypting module that has both encrypting and decrypting functions. The encrypting module encrypts message addresses and passes the encrypted address back to the find address module as a unique identifier to replace the message address.

The protection system 105 also has a find identifier module that is used to locate the unique identifier that has replaced the message address. The find identifier module passes the located identifier to the encrypting module for decrypting, receives a message address from the encrypting module and replaces the unique identifier with the message address.

The protection system 105 also has an address book module to monitor the address book 103 of the messaging client 101. When this module is notified of new address entries, the module passes the message address to the encrypting module, receives the encrypted address from the encrypting module and replaces the address in the address book 103 with the encrypted address.

When protection system 105 is installed it requests notification by the messaging client 101 when a new message is received and when a message is about to be sent.

The protection system 105 also includes a scanning module for scanning message folder 102 and message address book 103. The scanning module uses the find address module to locate message addresses and the encrypting module to encrypt any message addresses found.

During installation the installation component of protection system 105 uses the scanning modules and encrypting modules to encrypt message addresses in message folders 102 and message addresses in address books 103.

After a user composes a new outgoing message, and causes the messaging client 101 to send the message, the protection system 105 receives notification that a message is about to be sent. Encrypted addresses within the message are then decrypted before the message is sent to the server 110.

On receipt of a new message, the protection system 105 is notified and any addresses in the message are encrypted by the encryption module. All message addresses entering the messaging client are thus encrypted.

As all new message addresses are encrypted, when messages are subsequently saved in the various folders 102 within the messaging client 101, such as the Inbox, they are stored with encrypted message addresses. Message addresses stored in the address book 103 are also stored in an encrypted form as the addresses have been encrypted when messages enter the system.

The address book 103 is where details of contacts are stored, including message addresses. In the case of Microsoft Outlook Express, this is the Windows Address Book (WAB). The interception component monitors all changes to the address book. Whenever a new contact is added, the address book monitoring module of protection system 105 encrypts the message address.

The software uses an encryption key, unique to each user, to prevent viruses from decrypting message addresses. This technique makes it difficult for a virus to duplicate entries from a user.

Further the software can be used with message address servers 111 such as Microsoft Exchange or an LDAP Server. Address servers 111 store public addresses such as those addresses required to locate local users of the system and message addresses located outside the system. When composing a new message, the messaging client 101 may request addresses from a message address server 111. The protection system 105 receives notification of the reply and encrypts the addresses. The outgoing message is then sent in the normal way.

The protection system 105 of the present invention also provides the ability to decrypt and encrypt multiple message, folders or address books at once.

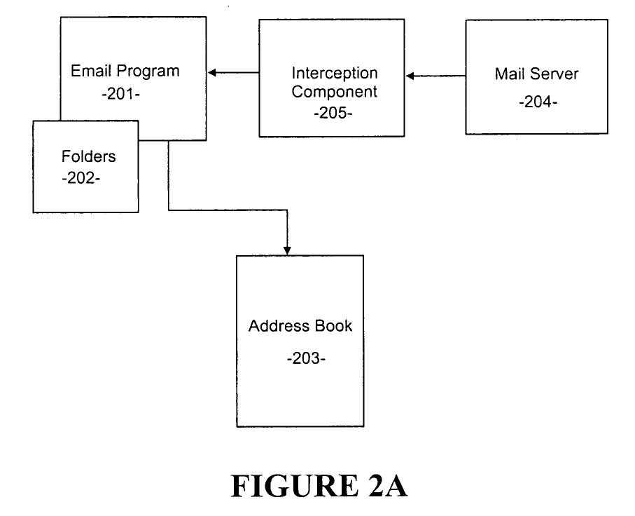

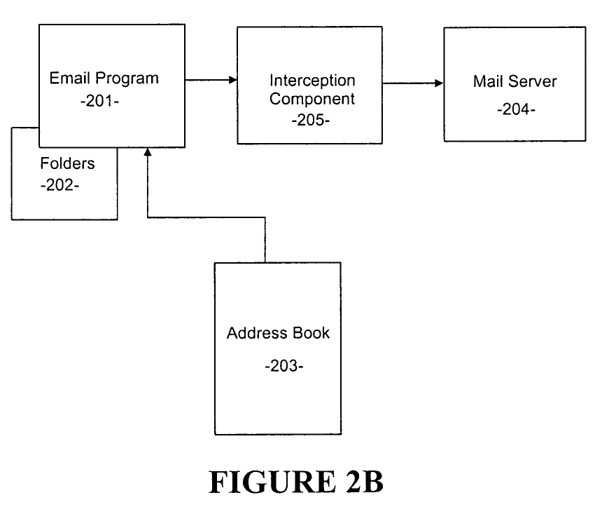

Referring to FIGS. 2A and 2B, the software implementing a further embodiment of the present invention includes an interception component 205 as part of an application program that operates on the same environment as the client messaging program 201 independently of the email client. The interception component 205 acts as an intermediary between the messaging client 201 and the messaging server 204, encrypting and decrypting message addresses. In the embodiment previously described the interception component was implemented as a plug-in.

During installation, according to an aspect of the invention, an installation component of the application program changes the messaging server settings of the messaging client 201 to refer to the interception component 205 instead of the messaging server 204. With respect to the messaging client 201, the interception component 205 acts as a messaging server. With respect to the messaging server 204, the interception component acts a client messaging program.

The interception component 205 of the present invention comprises an application program running on a computer. The application program has a module to receive messages from a messaging client 201 and a module to send messages to a messaging client 201. To communicate with a messaging server 204 the application program of interception component 205 has modules to send messages to the messaging server 204 and receive messages from the messaging server 204. The messaging client 201 receiving and sending modules and the server 204 receiving and sending modules implement the functionality of standard client and server messaging protocols.

The application program of interception component 205 has a find address module to locate messaging addresses in messages received from the messaging server 204. The find address module passes located addresses to an encrypting module that has both encrypting and decrypting functions. The encrypting module encrypts message addresses and passes the encrypted address back to the find address module as a unique identifier to replace the message address.

A find identifier module is used to locate the unique identifier that has replaced the message address. The find identifier module passes the located identifier to the encrypting module for decrypting, receives a message address from the encrypting module and replaces the unique identifier with the message address. The interception component 205 also has an address book module to monitor the address book 203 of the messaging client 201. This module detects new addresses added to the address book, passes the message address to the encrypting module, receives the encrypted address from the encrypting module and replaces the address in the address book 203 with the encrypted address.

The application program of interception component 205 includes an installation component which uses the scanning modules and encrypting modules to encrypt message addresses in message folders 202 and message addresses in address books 203. The installation component has functions to replace the messaging server settings of the messaging client 201 and store the existing messaging server settings of the client 201 in the application program of interception component 205 for use by the modules that send and receive messages for the messaging server 204.

The application program also includes a scanning module message folder and a message address book scanning module. Each scanning module uses the find address module to locate message addresses and the encrypting module to encrypt any message addresses found.

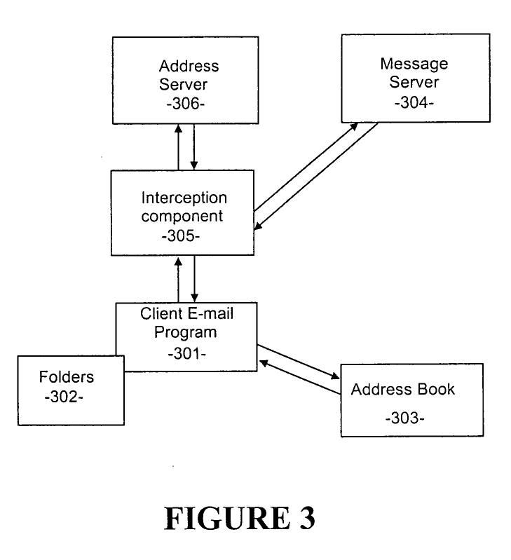

Referring to FIG. 3 a module of the interception component 305 to interface with a messaging address server 306 has functions to interact with both messaging clients 301 and messaging address server 306. The module receives requests for an address from the client 301 and forwards the requests to the server 306. After receiving the message address from server 306 the module passes the address to the encrypting module, receives the encrypted address and forwards the encrypted address to the messaging client 301.

The operation of the system of this embodiment of the address encryption aspect of the present invention in use is described with reference to FIG. 3 as follows. After a user composes a new outgoing message, and sends a message, the messaging client 301 forwards the message to the interception component 305. The interception component 305 decrypts the message address data and sends the message onto the messaging server 304.

To receive a new message, a user requests that the messaging client 301 check for new messages, the messaging client 301 requests that the interception component 305 checks with the messaging server 304 if there are new messages. If there are, the interception component 305 downloads the messages, identifies and encrypts the message addresses, and then passes the messages onto the messaging client 301. All message addresses entering the messaging client are thus encrypted.

Messaging clients may be set up to automatically check to see if there are new messages. In this case the messaging client 301 checks for new messages by checking with the interception component 305. The interception component 305 in turn checks with the messaging server 304. If there are new messages the interception component encrypts the addresses and forwards the messages to the client 301 in the same way as if the user had made the request to check for new mail.

As all message addresses entering the messaging client 301 are encrypted, when messages are subsequently saved in the various folders 302 within the messaging client 301, such as the Inbox, they are stored with encrypted message addresses. Message addresses stored in the address book 303 are also stored in an encrypted form as the addresses have been encrypted when messages enter the system.

The address book 303 is where details of contacts are stored, including message addresses. In the case of Microsoft Outlook Express, this is the Windows Address Book (WAB). The interception component monitors all changes to the address book. Whenever a new contact is added, the address book monitoring module of interception component 305 will encrypt the message address.

When the system component is installed for the first time, the installation component encrypts all existing message addresses found in the various folders 303 of the client message program 301, as well as all message addresses found in the address book 303.

The interception component uses an encryption key, unique to each user to prevent viruses from activating the interception component 304 in order to use it to decrypt message addresses. This technique makes it difficult for a virus to duplicate entries from a user.

The interception component can be used with message address servers 306 such as Microsoft Exchange or an LDAP Server. Address servers 306 store public addresses such as those addresses required to locate local users of the system and. message addresses located outside the system. When composing a new message, the messaging client 301 may request addresses from a message address server 306, the interception component 305 intercepts the request, makes the request of the message address server 306, receives the address and encrypts the addresses before forwarding onto the messaging client 301. The message is then sent in the normal way with the interception component 305 decrypting the message address before forwarding the message onto the messaging server 304.

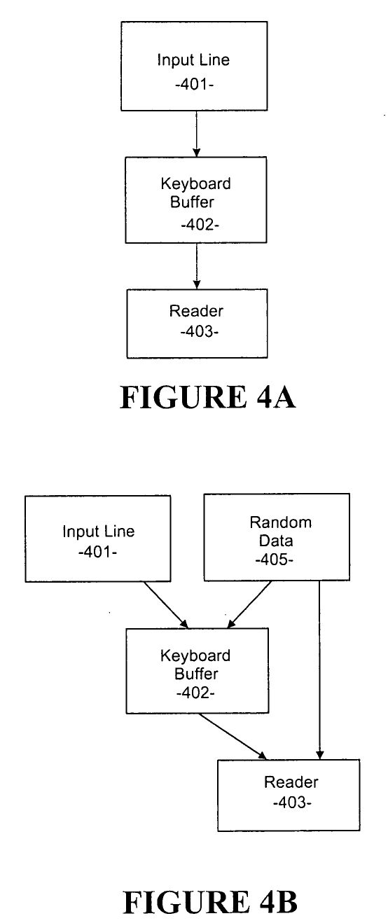

An additional safeguard provided by a further aspect of the present invention against keystroke loggers and sniffer programs is described with reference to FIGS. 4A and 4B. Referring to FIG. 4A, a conventional keyboard buffer 402 receives input data from a keyboard (not shown) over an input line 401. The contents of the buffer are read by a relevant software program over a suitable connection at 403.

Referring to FIG. 4B, an aspect of the present invention provides a keyboard buffer scrambling feature that adds randomly-generated characters into the keyboard buffer 402 between the password keystrokes which are input at 401 into keyboard buffer 402 from a keyboard or other or other data entry device. It will be appreciated that this aspect totally defeats keyboard sniffer programs. A Trojan horse program attempting to intercept a user's password only would receive a lot of meaningless characters.

As shown in FIG. 4B, a continuous stream of random characters are generated from a buffer scrambler 405 that randomly streams data in while someone enters a password to help prevent the password being picked up by a keyboard sniffer program. The buffer scrambler 405 comprises a random number generator, which also can be a cryptographic accelerator or other means for providing a variable and unpredictable stream of random characters that are sent as a data input 401 to the keyboard buffer 402. The contents of the keyboard buffer 402 are then read at 403 by a reader which is coupled with or otherwise has access shown at 407 to the random character stream provided by buffer scrambler 405. The reader 403 deletes the random characters inserted in the input data 401 from the contents of keyboard buffer 402.

By comparing the random characters with the contents of keyboard buffer 402, the reader 403 is able to reconstruct original (correct) input data 401 from the keyboard. Unauthorized software (such as keyboard buffer sniffer software) is able to access reader 403, but cannot determine the random character stream at 405 and is therefore unable to determine the input data 401.

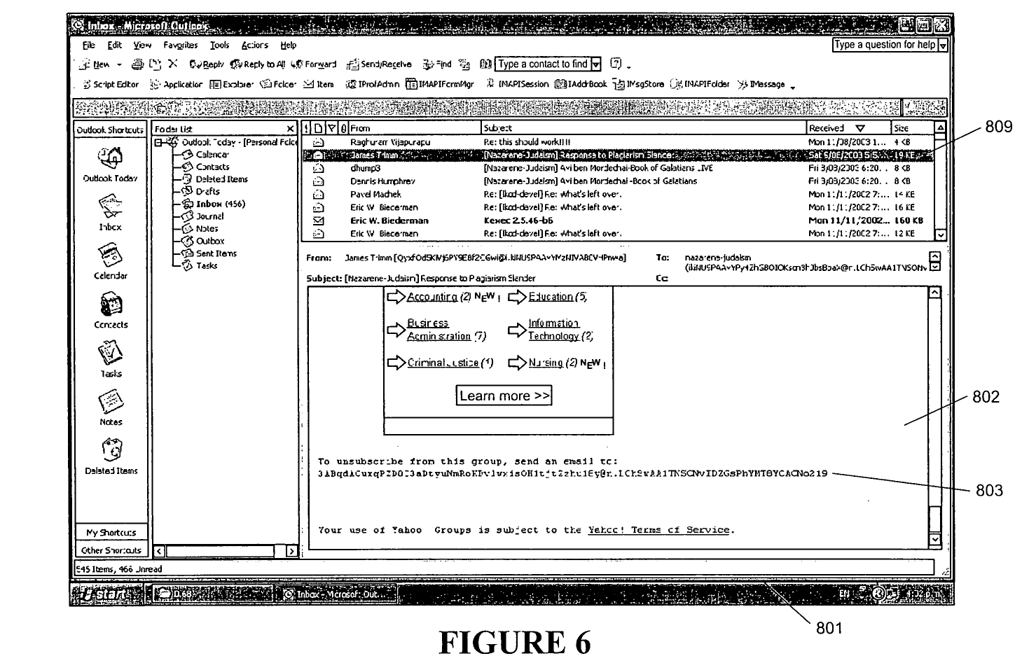

A further aspect of the invention will be described with reference to FIGS. 6 to 8. In FIG. 6A 801 operating with address encryption as set forth above is shown. When a message, file, object or link to a message, file or object is selected any address content of that message appears in encrypted form. In FIG. 6 at 802 the contents of a message folder are shown. The addresses 803 in the messages contained in the folder are encrypted or otherwise changed so they are not readable.

When a user using a mouse or other means selects the link 809 to a message, the message 802 is displayed with encrypted addresses. However according to this further aspect of the invention the software proceeds to alter the message to remove encryption and make all email addresses in that message readable.

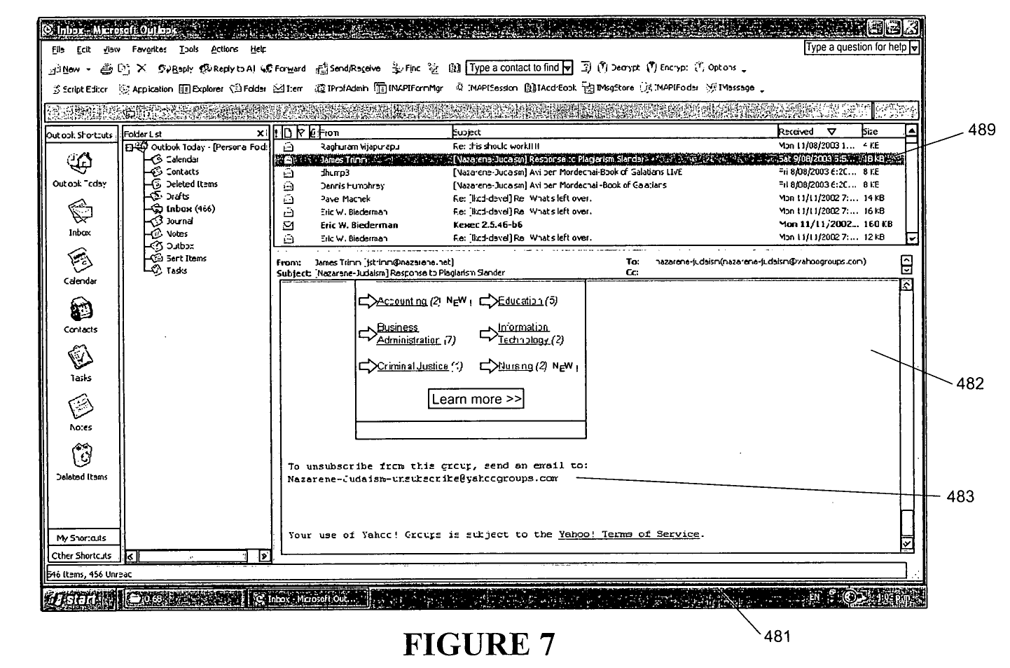

The protection system 105 upon receipt of the notification that the link is selected alters and in the preferred embodiment decrypts part of or all of the content of the message including the header information and makes it available to the user. Referring to FIG. 7 the message 482 displayed in the messaging client 481 is now displayed with the decrypted email address 483.

Upon notification that the link 489 has been de-selected the protection system 105 re-alters the data so that it includes the encrypted address. In the preferred embodiment the invention encrypts email address within the data so that the email addresses cannot be used to send messages.

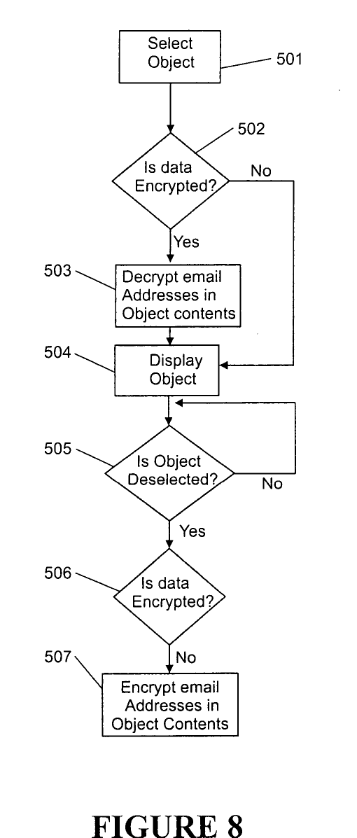

This process is illustrated in FIG. 8. When a user selects an object the protection system 105 is notified at step 501 and proceeds to step 502. At step 502 the system 105 checks to see if the object is encrypted. If the object is encrypted the protection system 105 proceeds to step 503 and the system then proceeds to step 504 and displays the decrypted object. If the object was not encrypted the protection system proceeds directly from step 502 to step 504 then it is just displayed.

The protection system 105 then waits at step 505 for notification that the object has been deselected. When the system 105 receives the notification it checks at step 506 whether the data is encrypted. If the data is not encrypted the protection system 105 proceeds to step 507 and encrypts the object.

In addition to replacing email addresses with identifiers the system on startup checks that files that could alter a message just before a message leaves the system are unchanged. The system does this by comparing the checksum of critical files with a stored checksum of those files.

As a further means to prevent viruses utilizing a messaging client to send out email the present invention modifies the messaging client to prevent the message send confirmation being activated by keystrokes. In addition the present invention replaces any button confirmation with a graphic confirmation. As a further protection the graphic confirmation is moved to a different location either at each login or each time a user prepares an email to send. This prevents a virus writer from establishing the coordinates of the graphic and programming the mouse to go to that position. The email client is modified by the installation component of the present system.

While the invention has been described in connection with what are presently considered to be the most practical and preferred embodiments, it is to be understood that the invention is not limited to the disclosed embodiments, but rather is intended to cover various modifications and equivalent arrangements which are included with the scope of the claims.

For example, the features of the invention are compatible with WAP or any mobile device enabling standard. Thus, an equivalent arrangement can be accomplished by implementing the keyboard buffer scrambling feature as well as other features described above in a PDA, cell phone or other computing device. Accordingly, persons of ordinary skill in this field are to understand that all such equivalent arrangements are to be included within the scope of the claims.

1. A system for preventing a computer virus from accessing message addresses, said system comprising an interception component adapted to communicate with a messaging client and a messaging server, said interception component including:
means for altering messages from said server destined for said client including:
means for identifying message addresses in messages received from said server;
means for replacing an identified message address in messages received from said server with a corresponding unique identifier; and
means for altering messages from said client destined for said server including:
means for identifying unique identifiers in messages received from said client; and
means for replacing an identified unique identifier with a corresponding message address before sending the message received from said client to said server.

2. A system for preventing a computer virus from accessing message addresses as claimed in claim 1 including:
means for identifying message addresses in stored mail of said messaging client and/or any address books of said client or client system; and
means for replacing an identified message address with a unique identifier in said stored mail and/or said any address books.

3. A system for preventing a computer virus from accessing message addresses as claimed in claim 1 including:
means for identifying unique identifiers in stored mail of said messaging client and/or any address books of said client or client system; and
means for replacing an identified unique identifier with a message address in said stored mail and/or said any address books.

4. A system for preventing a computer virus from accessing message addresses as claimed in claim 1 wherein:
said means for replacing an identified message address in messages received from said server with a corresponding unique identifier includes on encrypting engine; and said means for replacing an identified unique identifier with a corresponding message address before sending the message received from said client to said server includes a decrypting engine.

5. A system for preventing a computer virus from accessing message addresses as claimed in claim 2 wherein said means for replacing an identified message address with a unique identifier in said stored mail and/or said any address books includes an encrypting engine.

6. A system for preventing a computer virus from accessing message addresses as claimed in anyone of claim 3 wherein said means for replacing an identified unique identifier with a message address in said stored mail and/or said any address books includes a decrypting engine.

7. A system for preventing a computer virus from accessing message addresses as claimed in claim 1 including:
means for reconfiguring the message server settings of said messaging client to point to said interception component; and
means for storing original message server settings, wherein said original message server setting are accessible by said interception component.

8. A system for preventing a computer virus from accessing message addresses as claimed in claim 1 including means for monitoring one or more address books, said means for monitoring including:
means for identifying message addresses added to an address book; and
means for replacing an identified message address with a unique identifier in said address books.

9. A system for preventing a computer virus from accessing message addresses as claimed in claim 8 wherein said means for replacing an identified message address with a unique identifier in said address books includes an encrypting engine.

10. A system for preventing a computer virus from accessing message addresses as claimed in claim 4 wherein:
said encrypting engine; and
said decrypting engine, include means for receiving a unique user identifier from a messaging client user

11. A system for preventing a computer virus from accessing message addresses as claimed in claim 10 wherein said means for receiving a unique identifier from a messaging client user includes means for preventing keyboard sniffer programs from intercepting input comprising:
means for adding randomly generated characters into the keyboard buffer between password keystrokes; and
means for reading said keyboard buffer; and
means for reading the stream of said randomly generated characters and removing said randomly generated characters.

12. A system for preventing a computer virus from accessing message addresses as claimed in claim 1 including means for preventing keystrokes activating a send confirmation of a messaging client wherein said send confirmation can only be activated by other input means.

13. A system for preventing a computer virus from accessing message addresses as claimed in claim 12 wherein said send confirmation is a button and including means for replacing said message send confirmation button with a graphic.

14. A system for preventing a computer virus from accessing message addresses as claimed in claim 13 including means for moving said graphical randomly.

15. A system for preventing a computer virus from accessing message addresses as claimed in claim 12 wherein said send confirmation is activated by a mouse.

16. A system for preventing a computer virus from accessing message addresses as claimed in claim 1 wherein said means for altering messages from said server destined for said client comprises means for receiving messages from said server and forwarding said messages to said client; and
said means for altering messages from said client destined for said server comprises means for receiving messages from said client and forwarding the messages to said server.

17. A system for preventing a computer virus from accessing message addresses as claimed in claim 1 wherein said intervention component comprises a messaging client component for inclusion in a messaging client, said means for altering messages from said server destined for said client includes means for receiving notification of receipt of new messages from a messaging server by said messaging client, and said means for altering messages from said client destined for said server includes means for receiving notification that a message is to be sent to a messaging server by said messaging client.

18. A system for preventing a computer virus from activating a send confirmation of a messaging client comprising means for preventing keystrokes activating said send confirmation wherein said send confirmation can only be activated by other input means.

19. A system for preventing a computer virus from activating a send confirmation of a messaging client as claimed in claim 18 wherein said send confirmation is a button and including means for replacing said message send confirmation button with a graphic.

20. A system for preventing a computer virus from activating a send confirmation of a messaging client as claimed in claim 19 including means for moving said graphical randomly.

21. A system for preventing a computer virus from activating a send confirmation of a messaging client as claimed in claim 18 wherein said send confirmation is activated by a mouse.

22. A system for preventing keyboard sniffer programs from intercepting input via a keyboard comprising:
means for adding randomly generated characters into the keyboard buffer between password keystrokes; and
means for reading said keyboard buffer; and
means for reading the stream of said randomly generated characters and removing said randomly generated characters.

23. A method of preventing a computer virus from accessing message addresses, including the steps of:
altering messages from a messaging server destined for a messaging client including:
identifying message addresses in messages received from said server;
replacing an identified message address in messages received from said server with a corresponding unique identifier; and
altering messages from said client destined for said server including:
identifying unique identifiers in messages received from said message client; and
replacing an identified unique identifier with a corresponding message address before sending the message received from said client to said server.

24. A method of preventing a computer virus from accessing message addresses as claimed in claim 23 including the steps of:
identifying message addresses in stored mail of said messaging client and/or any address books of said client or client system; and
replacing an identified message address with a unique identifier in said stored mail and/or said any address books.

25. A method of preventing a computer virus from accessing message addresses as claimed in claim 23 including the steps of:
identifying unique identifiers in stored mail of said messaging client and/or any address books of said client or client system; and
replacing an identified unique identifier with a message address in said stored mail and/or said any address books.

26. A method of preventing a computer virus from accessing message addresses as claimed in claim 23 wherein:
replacing an identified message address in messages received from said server with a corresponding unique identifier includes the step of encrypting said message address; and
replacing an identified unique identifier with a corresponding message address before sending the message received from said client to said server includes the step of decrypting said unique identifier.

27. A method of preventing a computer virus from accessing message addresses as claimed in claim 24 wherein said step of replacing an identified message address with a unique identifier in said stored mail and/or said any address books includes the step of encrypting said message address.

28. A method of preventing a computer virus from accessing message addresses as claimed in claim 25 wherein step of replacing an identified unique identifier with a message address in said stored mail and/or said any address books includes the step of decrypting said unique identifier.

29. A method of preventing a computer virus from accessing message addresses as claimed in claim 23 including the steps of:
reconfiguring the message server settings of said messaging client; and
storing original message server settings, wherein said original message server setting are used when
receiving messages from said messaging server; and
forwarding message to said server.

30. A method of preventing a computer virus from accessing message addresses as claimed in claim 23 including the step of monitoring one or more address books, said step of monitoring including the steps of:
identifying message addresses added to an address book; and
replacing an identified message address with a unique identifier in said address books.

31. A method of preventing a computer virus from accessing message addresses as claimed in claim 30 wherein said step of replacing an identified message address with a unique identifier in said address books includes the step of encrypting said message address.

32. A method of preventing a computer virus from accessing message addresses as claimed in claim 26 wherein said steps of:
encrypting said message address; and
decrypting said unique identifier
include the step of receiving a unique user identifier from a messaging client user

33. A method of preventing a computer virus from accessing message addresses as claimed in claim 32 wherein said steps of receiving a unique identifier from a messaging client user includes the step of preventing keyboard sniffer programs from intercepting input including the steps of:
adding randomly generated characters into the keyboard buffer between password keystrokes; and
reading said keyboard buffer; and
reading the stream of said randomly generated characters and removing said randomly generated characters.

34. A method of preventing a computer virus from accessing message addresses as claimed in claim 23 including the steps of preventing keystrokes activating a send confirmation of a messaging client wherein said send confirmation can only be activated by other input means.

35. A method of preventing a computer virus from accessing message addresses as claimed in claim 34 wherein said send confirmation is a button and including the step of replacing said message send confirmation button with a graphic.

36. A method of preventing a computer virus from accessing message addresses as claimed in claim 35 including the steps of moving said graphical randomly.

37. A method of preventing a computer virus from accessing message addresses as claimed in claim 34 wherein said send confirmation is activated by a mouse.

38. A method of preventing a computer virus from accessing message addresses as claimed in claim 23 wherein said step of altering messages from a messaging server destined for a messaging client includes receiving messages from a messaging server and forwarding said messages to a messaging client; and
said step of altering messages from said client destined for said server includes receiving messages from said client and forwarding the messages to said server.

39. A method of preventing a computer virus from accessing message addresses as claimed in claim 23 wherein said step of altering messages from a messaging server destined for a messaging client includes receiving notification of receipt of new messages from a messaging server by said messaging client, and said step of altering messages from said client destined for said server includes receiving notification that a message is to be sent to a messaging server by said messaging client.

40. A method of preventing a computer virus from activating a send confirmation of a messaging client comprising the step of preventing keystrokes activating said send confirmation wherein said send confirmation can only be activated by other input means.

41. A method of preventing a computer virus from activating a send confirmation of a messaging client as claimed in claim 40 wherein said send confirmation is a button and including the step of replacing said message send confirmation button with a graphic.

42. A method of preventing a computer virus from activating a send confirmation of a messaging client as claimed in claim 41 including the step of moving said graphical randomly.

43. A method of preventing a computer virus from activating a send confirmation of a messaging client as claimed in claim 40 wherein said send confirmation is activated by a mouse.

44. A method of preventing keyboard sniffer programs from intercepting input via a keyboard including the steps of:
adding randomly generated characters into the keyboard buffer between password keystrokes; and
reading said keyboard buffer; and
reading the stream of said randomly generated characters and removing said randomly generated characters.

45. A system comprising:
an email or messaging server which sends and receives messages including a message address;
an email or messaging interface which replaces said external address with a unique identifier; and
an email or messaging client which sends and receives messages including a unique identifier.

46. A system for preventing a computer virus from accessing message addresses, said system comprising an interception component adapted to communicate with a messaging client and a messaging server, said interception component including:
means for receiving messages from said server and forwarding said messages to said client;
means for identifying message addresses in messages received from said server; and
means for replacing an identified message address in messages received from said server with a corresponding unique identifier.

47. A system for preventing a computer virus from accessing message addresses, said system comprising an interception component adapted to communicate with a messaging client and a messaging server, said interception component including:
means for receiving messages from said client and forwarding the messages to said server;
means for identifying unique identifiers in messages received from said client; and
means for replacing an identified unique identifier with a corresponding message address before sending the message received from said client to said server.

48. A method of changing data within a data object comprising the steps of:
receiving notification that a user has selected said object;
changing the contents of the said object by decrypting all or part of the contents of the object; and
displaying at least part of said changed object.

49. A method as claimed in claim 48 further comprising the steps of:
receiving notification that said user has de-selected said object; and
changing the contents of said object by encrypting all or part of the contents of the object.

50. A method as claimed in claim 48 wherein said method is used within an email application and said email application provides the notification of change.

51. A method as claimed in claim 48 wherein said method is used within a file system program and said file system display program provides said notification.

52. A method as claimed in claim 48 wherein said part of the content encrypted and decrypted is an email address.
